(19) United States
(12) Patent Application Publication
(10) Pub. No.: US 2015/0036659 A1
(43) Pub. Date: Feb. 5, 2015

(54) Local Networks

(71) Applicant: Nokia Solutions and Networks Oy, Espoo (FI)

(72) Inventors: Seppo Ilmari Vesterinen, Oulunsalo (FI); Yang Liu, Beijing (CN); Haitao Li, Beijing (CN); Yixue Lei, Beijing (CN); Kodo Shu, Beijing (CN)

(21) Appl. No.: 14/379,319

(22) PCT Filed: Feb. 21, 2012
(86) PCT No.: PCT/CN2012/071395

§ 371 Date: Aug. 18, 2014

(51) Int. Cl. H04W 36/22

(52) U.S. Cl. CPC H04W 36/22
USPC 370/331

(57) ABSTRACT

The invention relates to an apparatus including at least one processor and at least one memory including a computer program code, the at least one memory and the computer program code configured to, with the at least one processor, cause the apparatus at least to: provide access to a network and needed bearers locally, and obtain offload bearer traffic from an umbrella node under control of the umbrella node in such a manner that a core network sees the offload bearer traffic as internal umbrella node traffic.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Along with development of the LTE system, high-speed data service has been seen as one of the most important requirements. Higher data rates are seen to improve user experience in local area networks as well. Thus, providing local service with high speed data rate has raised an interest.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: provide access to a network and needed bearers locally, and obtain offload bearer traffic from an umbrella node under control of the umbrella node in such a manner that a core network sees the offload bearer traffic as internal umbrella node traffic.

According to an aspect of the present invention, there is provided an apparatus comprising: at least one processor and at least one memory including a computer program code, the at least one memory and the computer program code configured to, with the at least one processor, cause the apparatus at least to: offload bearer traffic to a local access point, and control the offload bearer traffic in such a manner that a core network sees the offload bearer traffic as internal umbrella node traffic.

According to yet another aspect of the present invention, there is provided a method comprising: providing access to a network and needed bearers locally, and obtaining offload bearer traffic from an umbrella node under control of the umbrella node in such a manner that a core network sees the offload bearer traffic as internal umbrella node traffic.

According to yet another aspect of the present invention, there is provided a method comprising: offloading bearer traffic to a local access point, and controlling the offload bearer traffic in such a manner that a core network sees the offload bearer traffic as internal umbrella node traffic.

According to yet another aspect of the present invention, there is provided an apparatus comprising: means for providing access to a network and needed bearers locally, and means for obtaining offload bearer traffic from an umbrella node under control of the umbrella node in such a manner that a core network sees the offload bearer traffic as internal umbrella node traffic.

According to yet another aspect of the present invention, there is provided an apparatus comprising: means for offloading bearer traffic to a local access point, and means for controlling the offload bearer traffic in such a manner that a core network sees the offload bearer traffic as internal umbrella node traffic.

According to yet another aspect of the present invention, there is provided a computer program embodied on a computer-readable storage medium, the computer program comprising program code for controlling a process to execute a process, the process comprising: providing access to a network and needed bearers locally, and obtaining offload bearer traffic from an umbrella node under control of the umbrella node in such a manner that a core network sees the offload bearer traffic as internal umbrella node traffic.

According to yet another aspect of the present invention, there is provided a computer program embodied on a computer-readable storage medium, the computer program comprising program code for controlling a process to execute a process, the process comprising: offloading bearer traffic to a local access point, and controlling the offload bearer traffic in such a manner that a core network sees the offload bearer traffic as internal umbrella node traffic.

### LIST OF DRAWINGS

Some embodiments of the present invention are described below, by way of example only, with reference to the accompanying drawings, in which

FIG. 1A illustrates examples of systems;

FIG. 1B illustrates other examples of systems;

FIG. 2 is a flow chart;

FIG. 3 is another flow chart;

FIG. 4 shows an example of signalling;

FIG. 5 illustrates examples of apparatuses, and

FIG. 6 illustrates other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution (LTE), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution advanced (LTE-A,), global system for mobile communication (GSM), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, and mobile ad-hoc networks (MANETs).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a combination of signals on each of the subcarriers. Further, each OFDM symbol is preceded by a cyclic prefix (CP), which is used to decrease Inter-Symbol Interference.

Single-carrier FDMA (SC-FDMA) is a frequency-division multiple access scheme. The SC-FDMA produces a single-carrier transmission signal, in contrast to OFDMA which is a multi-carrier transmission scheme. Unlike in OFDM, SC-FDMA subcarriers are not independently modulated.

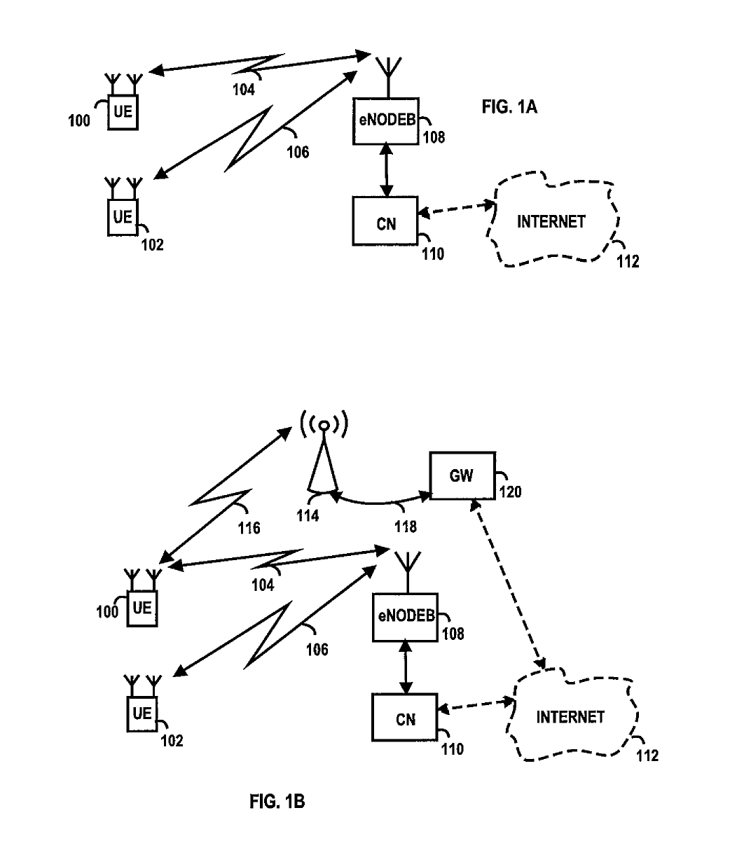

FIG. 1A depicts examples of simplified system architectures only showing some elements and functional entities, all being logical units, whose implementation may differ from what is shown. The connections shown in FIG. 1A are logical connections; the actual physical connections may be different. It is apparent to a person skilled in the art that the system typically comprises also other functions and structures than those shown in FIG. 1A.

The embodiments are not, however, restricted to the system given as an example but a person skilled in the art may apply the solution to other communication systems provided with necessary properties.

FIG. 1A shows a part of a radio access network based on E-UTRA, LTE, or LTE-Advanced (LTE-A).

FIG. 1A shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment. Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule downlink transmissions to user devices. Such required information is usually signalled to the (e)NodeB by using uplink signalling.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The mobility management entity is a control element in an evolved packet core (EPC).

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM, some examples are a full-size SIM, mini-SIM, micro-SIM and embedded-SIM), including, but not limited to, the following types of devices: a mobile station (mobile phone), smartphone, personal digital assistant (PDA), plug-in data modem (such as a universal serial bus, USB stick), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1A) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1A may provide any kind of these cells. A cellular radio system may be implemented as a multilayer network including several kinds of cells and some of the cells may belong to different radio access technology layers. Typically, in multilayer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)Node Bs has been introduced. Typically, a network which is able to use “plug-and-play” (e)Node (e)Bs, may include, in addition to Home (e)Node Bs (H(e)nodeBs), a home node B gateway, or HNB-GW (not shown in FIG. 1A). A HNB Gateway (HNB-GW), which is typically installed within an operator's network may aggregate traffic from a large number of HNBs back to a core network.

Heterogenenous networks “HetNets” are means for expanding mobile network capacity. A heterogeneous network typically comprises devices using multiple radio access technologies, architectures, transmission solutions, etc. The heterogeneous networks may also create challenges due to the deployment of different wireless nodes such as macro/micro (e)NBs, pico (e)NBs, and Home (e)NBs creating a multi-layer network using a same spectrum resource. Usually, centralized network planning and optimization is not well-suited to the individualistic nature of user-deployed cells, such as femtocells. Thus cooperation between nodes in a decentralized and distributed manner may be provided. Cooperative heterogeneous networks are also known as “coHetNets”.

A local area network (LAN) is designed to provide networking capability with a group of devices in at least substantially close proximity to each other, such as in an office building, school, home, university campus or shopping center. A local area network may also be implemented as a wireless network. In the case of a wireless local area network, a connection through an access point to the Internet or other external network is provided. A wireless local area network is suitable for many applications, for example for using cloud services. It gives users a mobility option to move around within a local coverage area.

Along with development of the LTE system, high-speed data service has been seen as one of the most important requirements. Higher data rates are seen to improve user experience in local area networks as well. Thus, providing local service with high speed data rate has raised an interest.

One option to provide higher data rates is a recently launched long term evolution local area network (LTE-LAN). The LTE-LAN is basically assumed to be based on LTE technology but it is more focused on some local area use cases and scenarios. One feasible architecture option is that an LTE-LAN access point (AP) is under the control of an umbrella cell node, such as a macro (e)NB (correspondingly to a sub-system of the (e)NB) and the access point is coupled to a core network via the backhaul of the umbrella cell node. Thus no direct interface between the access point and the core network is needed, instead, the node to which the access point is coupled to acts like a concentrator or controller in the radio access network (RAN) side.

In an exemplary system, a local access point, such as a local node (such as an LTE-LAN access point), is coupled to a macro (e)NB with a backhaul, and a user device has a connection to the macro (an umbrella) (e)NB. When the user device moves into the coverage area of the access point, an inbound handover procedure (in this example from the macro eNB to the HeNB) may be triggered, and after the handover with regard to the air interface has been completed, a path switch procedure will be performed by the target local access point to complete the handover procedure with regard to a core network.

During the handover procedure, path switch procedures on X2 (interface between two nodes) based handover, or signaling via a mobility management entity (MME) on even more complex S1 (backhaul interface) based handover procedure cause signaling burden on a core network, especially if many local access points are provided and handovers take place frequently.

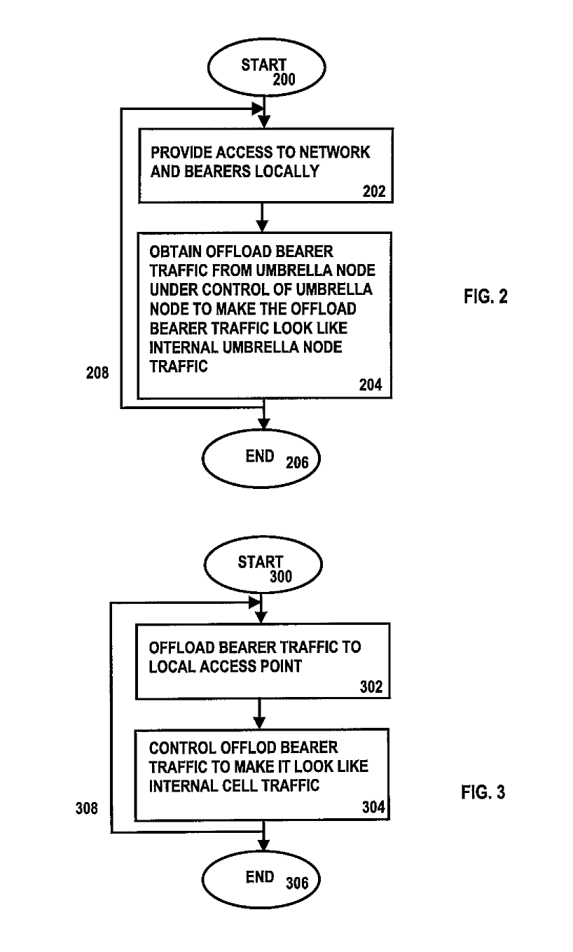

In the following, some embodiments are described in further details in relation to FIG. 2.

The embodiment starts in block 200. The embodiment may be carried out by a node, host or server providing local area network access point services. The access point services may comprise providing autonomously a local internet protocol (IP) access.

In block 202, access to a network and needed bearers is provided locally.

A local access point, such as a long term evolution local area network (LTE-LAN) access point, may provide local Internet Protocol access services to a user device for creating a direct access to a local network or to the Internet via a local default gateway (GW) correspondingly to local area networks, such as Wi-Fi, as usual. That is local traffic may be routed directly to the local access network and/or to the Internet without causing load to a core network.

In block 204 offload bearer traffic from an umbrella node is obtained under control of the umbrella node in such a manner that a core network sees the offload bearer traffic as internal umbrella node traffic.

When an umbrella node detects that at least part of user device traffic may be offloaded to one or more local access points, a service transfer may be coordinated between the umbrella node and the local access point(s). Typically, traffic is transferred by transferring bearers carrying the traffic. A bearer to be transferred may be an evolved packet system (EPS) bearer according to EPS mobility management (EMM) protocol. The EPS protocol also provides security control for non-access stratum (NAS) protocols. An “EPS bearer” typically means a virtual connection providing bearer service, such as a data transport service.

After the transfer, the umbrella node may still maintain the control of the services and user plane traffic towards a core network.

In an embodiment, system architecture may be as follows: a local access point is coupled to an umbrella node through a local interface. From the evolved packet core's (EPC's) point of view, the local access point looks like a cell under the umbrella node. An interface between the local access point and the umbrella node may support some functions of S1 and X2 interfaces, such as radio access bearer (E-RAB) management, context management, NAS transport, paging and/or handover control. However, this “local” control is transparent to a core network. A user device may use current LTE-Uu interface to communicate with the umbrella node and the local access point. The interface may also be modified according to needs. It should be appreciated, that the local access point may support local Internet protocol (IP) access bearer traffic of the user device (such as LTE-LAN bearer service related traffic) routed directly to the local network and/or to the Internet via a local gateway. The umbrella node acts as a controller towards the local access network when user device's bearer services are offloaded to the local access network. The umbrella node may thus control its “internal issues” such as decisions about intra-node/inter-cell handovers that can be made without a request from the EPC.

The embodiment ends in block 206. The embodiment is repeatable in many ways. One example is shown by arrow 208 in FIG. 2.

Another embodiment starts in block 300. The embodiment may be carried out by a node, host or server providing an umbrella or macro node services.

In block 302, bearer traffic is offloaded to a local access point.

When an umbrella node detects or determines that at least part of user device traffic may be offloaded to one or more local access points, the service transfer may be coordinated between the umbrella node and the local access point. Typically, traffic is transferred by transferring bearers carrying the traffic. A bearer to be transferred may be an EPS bearer according to EPS mobility management (EMM) protocol. The EPS protocol also provides security control for non-access stratum (NAS) protocols. An “EPS bearer” typically means a virtual connection providing bearer service, such as a data transport service.

In block 304, the offload bearer traffic is controlled in such a manner that a core network sees the offload bearer traffic as internal umbrella node traffic.

After the offload bearer traffic transfer, an umbrella node may still maintain the control of the services and user plane traffic towards a core network.

In an embodiment, system architecture may be as follows: a local access point is coupled to an umbrella node through a local interface. From the evolved packet core's (EPC's) point of view, the local access point looks like a cell under the umbrella node. An interface between the local access point and the umbrella node may support some functions of S1 and X2 interfaces, such as radio access bearer (E-RAB) management, context management, NAS transport, paging and/or handover control. However, this “local” control is transparent to a core network. A user device may use current LTE-Uu interface to communicate with the umbrella node and the local access point. The interface may also be modified according to needs. It should be appreciated, that the local access point may support local IP access bearer traffic of the user device (such as LTE-LAN bearer service related traffic) routed directly to the local network and/or to the Internet via a local gateway. The umbrella node acts as a controller towards the local access network when user devices bearer services are offloaded to the local access network. The umbrella node may thus control its “internal issues” such as decisions about intra-node/inter-cell handovers that can be made without a request from the EPC.

The embodiment ends in block 306. The embodiment is repeatable in many ways. One example is shown by arrow 308 in FIG. 3.

FIG. 1B depicts a simplified example of a system which embodiments may be applied to. This simplified example is shown herein only for clarification purposes and it should not be taken as a limiting illustration.

FIG. 1B shows an example of local area network provided by local access point 114 in the coverage area of an umbrella or macro node provided by (e)NB 108. The example is based on the exemplary network illustrated in the FIG. 1A. Similar reference numbers refer to similar parts in both FIGS. 1A and 1B. In this exemplary system, the user device 100 has an access to the local network via wireless interface 116. The local access point may provide access to the Internet locally via interface 118 and local gateway 120. The local access point is also capable to receive offload traffic from the macro node.

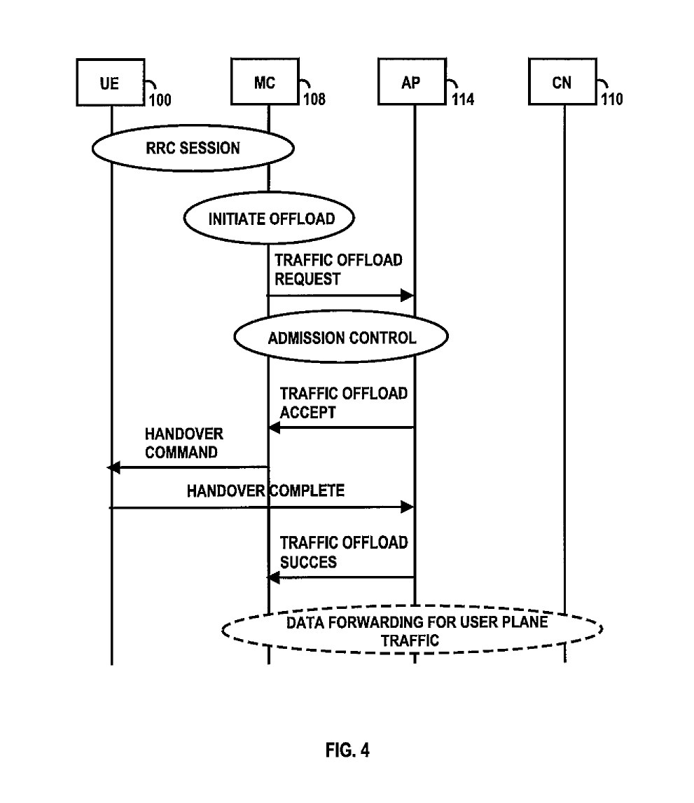

In the following, an exemplifying signaling flow for traffic offload is now explained in further detail by means of FIG. 4. The exemplifying signalling flow is based on the simplified system example of FIG. 1B. The example is shown herein only for clarification purposes and it should not be taken as a limiting illustration.

An interface between a local access point 114 and an umbrella node 108 may be established. The umbrella node may set unique “virtual cell identifier(s)” for the local access point in a similar manner as the access point cell were a cell provided by the umbrella node towards EPC (MME) in the core network 110. Thus signaling may be made transparent to the core network.

The umbrella node may initiate a traffic offload procedure on the basis of measurement reports obtained from the user device 100 and send a traffic offload request message to the local access point 114. The local access point may decide whether to accept this offload procedure based on admission control.

If the local access point accepts the traffic offload request, it may response by an accept message (ACK). The message may also comprise a handover command message. The umbrella node 108 may forward this message to the user device 100 to execute a handover procedure for the air interface, and the user device may establish a connection to the local access point. The user device may transmit a handover complete message.

The local access point may inform the umbrella node about the success of the traffic offload procedure. User plane traffic path for offloaded bearers may also be switched. Traffic in relation to local bearer services may be routed directly from the local access point to the local network that is to say it does not need to be routed to the umbrella node or serving gateway in the core network. On the control-plane, the offload procedure may also be used to establish user device dedicated signaling connection from the local access point to the umbrella node that continues controlling signalling to the core network in order to make the offload procedure look like an intra-cell handover in other words a cell change within the same (e)NB.

Hence, signaling burden caused to a core network (due to path switch procedures, for instance) may be relieved in a local area network.

The steps/points, signaling messages and related functions described above in FIGS. 2 and 3 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting, sending and/or receiving may herein mean preparing a data conveyance, transmission and/or reception, preparing a message to be conveyed, transmitted and/or received, or physical transmission and/or reception itself, etc. on a case by case basis. The same principle may be applied to terms transmission and reception as well.

An embodiment provides an apparatus which may be any relay node, node, host, webstick, server or any other suitable apparatus capable to carry out processes described above in relation to FIG. 2.

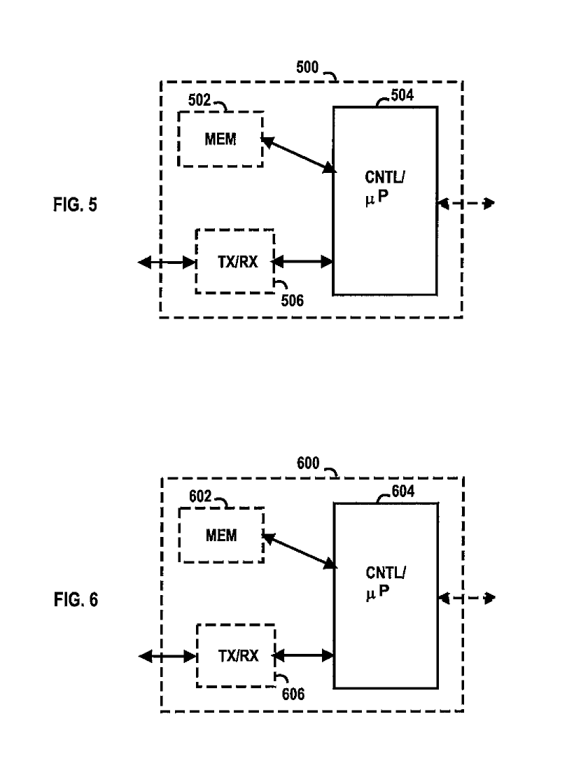

FIG. 5 illustrates a simplified block diagram of an apparatus according to an embodiment.

As an example of an apparatus according to an embodiment, it is shown apparatus 500, including facilities in control unit 504 (including one or more processors, for example) to carry out functions of embodiments according to FIG. 2. The facilities may be software, hardware or combinations thereof as described in further detail below.

Another example of apparatus 500 may include at least one processor 504 and at least one memory 502 including a computer program code, the at least one memory and the computer program code configured to, with the at least one processor, cause the apparatus at least to: provide access to a network and needed bearers locally, and obtain offload bearer traffic from an umbrella node under control of the umbrella node in such a manner that a core network sees the offload bearer traffic as internal umbrella node traffic.

Yet another example of an apparatus comprises means 504 (506) for providing access to a network and needed bearers locally, and means 504 (506) for obtaining offload bearer traffic from an umbrella node under control of the umbrella node in such a manner that a core network sees the offload bearer traffic as internal umbrella node traffic.

Yet another example of an apparatus comprises an access unit configured to provide access to a network and needed bearers locally, and an obtainer configured to obtain offload bearer traffic from an umbrella node under control of the umbrella node in such a manner that a core network sees the offload bearer traffic as internal umbrella node traffic.

It should be understood that the apparatuses may include or be coupled to other units or modules etc., such as those used in or for transmission and/or reception. This is depicted in FIG. 5 as optional block 506. In FIG. 5, block 506 includes parts/units/modules needed for reception and transmission, usually called a radio front end, RF-parts, radio parts, radio head, etc.

Although the apparatuses have been depicted as one entity in FIG. 5, different modules and memory may be implemented in one or more physical or logical entities.

An embodiment provides an apparatus which may be any relay node, node, host, webstick, server or any other suitable apparatus capable to carry out processes described above in relation to FIG. 3.

FIG. 6 illustrates a simplified block diagram of an apparatus according to an embodiment.

As an example of an apparatus according to an embodiment, it is shown apparatus 600, including facilities in control unit 604 (including one or more processors, for example) to carry out functions of embodiments according to FIG. 3. The facilities may be software, hardware or combinations thereof as described in further detail below.

Another example of apparatus 600 may include at least one processor 604 and at least one memory 602 including a computer program code, the at least one memory and the computer program code configured to, with the at least one processor, cause the apparatus at least to: offload bearer traffic to a local access point, and control the offload bearer traffic in such a manner that a core network sees the offload bearer traffic as internal umbrella node traffic.

Yet another example of an apparatus comprises means 604 (606) for offloading bearer traffic to a local access point, and means 604 (606) for controlling the offload bearer traffic in such a manner that a core network sees the offload bearer traffic as internal umbrella node traffic.

Yet another example of an apparatus comprises an offloader configured to offload bearer traffic to a local access point, and a controller configured to control the offload bearer traffic in such a manner that a core network sees the offload bearer traffic as internal umbrella node traffic.

It should be understood that the apparatuses may include or be coupled to other units or modules etc., such as those used in or for transmission and/or reception. This is depicted in FIG. 6 as optional block 606. In FIG. 6, block 606 includes parts/units/modules needed for reception and transmission, usually called a radio front end, RF-parts, radio parts, radio head, etc.

Although the apparatuses have been depicted as one entity in FIG. 6, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be at least one software application, module, or unit configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation. Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
provide access to a network and needed bearers locally, and
obtain offload bearer traffic from an umbrella node under control of the umbrella node in such a manner that a core network sees the offload bearer traffic as internal umbrella node traffic.

2. The apparatus of claim 1, wherein the access is provided to the Internet via a local gateway.

3. The apparatus of claim 1, wherein the obtaining the offload bearer traffic is carried out by transferring EPS bearers.

4. The apparatus of claim 1, further causing the apparatus to: be coupled to an umbrella node through a local interface supporting radio access bearer (E-RAB) management, context management, non-access stratum (NAS) transport, paging and handover control.

5. The apparatus of claim 1, further comprising causing the apparatus to:
maintain the offload bearer traffic under the control of the umbrella node.

6. The apparatus of claim 1, the apparatus comprising server, host or node.

7. (canceled)

8. An apparatus comprising:
at least one processor and at least one memory including a computer program code, the at least one memory and the computer program code configured to, with the at least one processor, cause the apparatus at least to:
offload bearer traffic to a local access point, and
control the offload bearer traffic in such a manner that a core network sees the offload bearer traffic as internal umbrella node traffic.

9. The apparatus of claim 8, wherein the offloading of the bearer traffic is carried out by transferring EPS bearers.

10. The apparatus of claim 8, further comprising causing the apparatus to:
determine to offload at least part of user device traffic to one or more local access points, and
coordinate the service transfer to the local access point.

11. The apparatus of claim 8, further comprising causing the apparatus to:
be coupled to a local access point through a local interface supporting radio access bearer (E-RAB) management, context management, non-access stratum (NAS) transport, paging and handover control.

12. The apparatus of claim 8, further comprising causing the apparatus to:
control intra-node and/or inter-cell handovers.

13. The apparatus of claim 8, further comprising causing the apparatus to:
set at least one virtual cell identifier for the local access point for making signaling transparent to the core network.

14. (canceled)

15. (canceled)

16. A method comprising:
providing access to a network and needed bearers locally, and
obtaining offload bearer traffic from an umbrella node under control of the umbrella node in such a manner that a core network sees the offload bearer traffic as internal umbrella node traffic.

17. The method of claim 16, wherein the access is provided to the Internet via a local gateway.

18. The method of claim 16, wherein the obtaining the offload bearer traffic is carried out by transferring EPS bearers.

19. The method of claim 16, further comprising:
coupling to an umbrella node through a local interface supporting radio access bearer (E-RAB) management, context management, non-access stratum (NAS) transport, paging and handover control.

20. The method of claim 16, further comprising:
maintaining the offload bearer traffic under the control of the umbrella node.

21. (canceled)

22. A method comprising:
offloading bearer traffic to a local access point, and
controlling the offload bearer traffic in such a manner that a core network sees the offload bearer traffic as internal umbrella node traffic.

23. The method of claim 22, wherein the offloading of the bearer traffic is carried out by transferring EPS bearers.

24. The method of claim 22, further comprising:
determining to offload at least part of user device traffic to one or more local access points, and
coordinating the service transfer to the local access point.

25. The method of claim 22, further comprising:
coupling to a local access point through a local interface supporting radio access bearer (E-RAB) management, context management, non-access stratum (NAS) transport, paging and handover control.

26. The method of claim 22, further comprising:
controlling intra-node and/or inter-cell handovers.

27. The method of claim 22, further comprising:
setting at least one virtual cell identifier for the local access point for making signaling transparent to the core network.

28. (canceled)

29. A computer program embodied on a computer-readable storage medium, the computer program comprising program code for controlling a process to execute a process, the process comprising:
providing access to a network and needed bearers locally, and
obtaining offload bearer traffic from an umbrella node under control of the umbrella node in such a manner that a core network sees the offload bearer traffic as internal umbrella node traffic.

30. A computer program embodied on a computer-readable storage medium, the computer program comprising program code for controlling a process to execute, a process, the process comprising:
offloading bearer traffic to a local access point, and
controlling the offload bearer traffic in such a manner that a core network sees the offload bearer traffic as internal umbrella node traffic.
